(19) United States
(12) Patent Application Publication
(10) Pub. No.: US 2007/0085843 A1
(43) Pub. Date: Apr. 19, 2007

(54) Audio information display in a multimode display device

(75) Inventors: Weng Keen Lam, Singapore (SG); Chunrui Zhang, Singapore (SG); Naing Win, Singapore (SG); Jun Cai, Singapore (SG)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/579,310

(22) PCT Filed: Nov. 16, 2004
(86) PCT No.: PCT/IB04/52444

§ 371 Date: May 16, 2006

(30) Foreign Application Priority Data
Nov. 20, 2003 (EP) 03104291.4

(51) Int. Cl. G09G 5/00

(52) U.S. Cl. 345/204

(57) ABSTRACT

The present invention relates to a multimode display device (101) comprising a display area, where said display device is, in a first mode, adapted for displaying displayfocused applications on the display area, where said display device is, in a second mode, adapted for displaying audio-specific information on the display area describing audio being played back and where the display device is, in a third mode, adapted for simultaneously displaying independent display-focused applications and audio-specific information on the display area, the device comprises: receiving means (307) adapted for receiving audio data comprising said audio-specific information; processing means (309) adapted for displaying said audio-specific information on said display area. Thereby the user can choose to view the audio-specific information on the display device, while listening to the audio. Because of the separate processing means for adding the audio-specific information on the display area, the information can be added without obstructing the view of the display-focused application. This can advantageously be used e.g. for the FM Radio feature in an LCD TV Monitor product, where the user can view the FM Radio channel frequency when selecting different radio broadcasting stations.

The present invention relates to a multimode display device of visually handling audio applications on the display area and a method for a multimode display device of visually handling audio applications on the display area.

In today's CRT TV, it is possible to select FM radio mode and receive radio broadcasting off-air, while displaying colored or dark background on the TV screen. It is also possible to display the FM Radio channel frequency on this same colored or dark background. This type of display will also be referred to as a multimode display device, being a display device having three modes. A first mode adapted for displaying display-focused applications on the display area e.g. a PC screen. A second mode adapted for displaying audio-specific information on the display area describing audio being played back e.g. the FM radio sound being the audio and the audio-specific information being the FM radio channel frequency. A third mode adapted for simultaneously displaying independent display-focused applications and audio-specific information on the display area.

In LCD TV the same concept for FM Radio can be incorporated. When this LCD TV is connected to a PC, via its VGA input, to function as a PC monitor, the user can switch to PC mode to display a PC screen. Moreover, a small TV screen (TV PIP) can be displayed by Picture-In-Graphic (PIG) or Picture-In-Picture (PIP) which is overlaid onto the PC screen. The TV PIP may display FM Radio channel frequency on colored or dark background as explained above, while receiving FM Radio broadcasting.

In the case of TV PIP, the user has the intention of leaving the small TV screen on while working with the window from the computer. This may cause a problem. For instance, the user has to use the Remote Control handset to shift the TV PIP away when it is obstructing the view of the PC window. However, in the case of “FM Radio” PIP (i.e., TV PIP displaying FM Radio channel frequency on colored or dark background) the user will find it cumbersome to keep shifting a significant area covering the PC window—and such area does not contain a useful picture for viewing, except for channel frequency indication. In addition, such channel frequency OSD would have been scaled down and become illegible.

EP 1133174 describes a broadcasting and communication receiver apparatus for displaying program-associated information. The display is split into separate zones for displaying programmes and associated information, respectively. The zone areas are dedicated and therefore the associated information could fill a considerable amount of the display area, even though the extra information is not needed by the user.

It is therefore an object of the invention to obtain a solution to the above mentioned problems and thereby to minimize the inconvenience experienced by the user while he uses a display device for a specific display-focused application such as e.g. monitor for a PC and simultaneously listens to an audio source which also can be presented on the display area of the display device.

This is obtained by a multimode display device comprising a display area, where said display device is, in a first mode, adapted for displaying display-focused applications on the display area, where said display device is, in a second mode, adapted for displaying audio-specific information on the display area describing audio being played back and where the display device is, in a third mode, adapted for simultaneously displaying independent display-focused applications and audio-specific information on the display area, the device comprises:

receiving means adapted for receiving audio data comprising said audio-specific information;

processing means adapted for displaying said audio-specific information on said display area.

Thereby the user can choose to view the audio-specific information on the display device, while listening to the audio. Because of the separate processing means for adding the audio-specific information on the display area, the information can be added without obstructing the view of the display-focused application. This especially because the separate processing ensures that the audio information can be sized and positioned in a position that obstructs the view of the display-focused application as little as possible. This can e.g. advantageously be used for the FM Radio feature in an LCD TV Monitor product, where the user can view the FM Radio channel frequency when selecting different radio broadcasting stations. It can of course also be applied for other types of displays e.g. plasma display, as well as other display from latest state-of-the-art.

In a specific embodiment the device comprises means for playing back said audio. Thereby the device is an all-in-one apparatus and the user does not have to purchase a number of apparatuses, which can be very space-consuming. Further, when the devices are integrated they can be optimized with regard to mutual compatibility.

In another embodiment the device further comprises storage means adapted for storing the audio-specific information and wherein the processing means is adapted for reading said audio-specific information from said storage means. Thereby the audio-specific information is constantly available either to the processing means displaying the information on the screen; this can e.g. be an advantage when the user wishes to change how the audio-specific information is being presented on the display, e.g. to change the color of the font describing the frequency of a radio channel.

In an embodiment the device comprises a connector for connecting an external audio source enabling the device to receive said audio data comprising audio-specific information from said audio source via said connector. Thereby it can be used for displaying audio-specific information from audio being played back from different sources, such as MP3 players, CD player and radios. By using a standard connector system such as e.g. USB existing audio players can be used in combination with the device, making is easy to customize the device.

In an embodiment the display area is an LCD display and the processing means for displaying said audio-specific information on said display area is a scaler comprised in said display device.

Thereby existing hardware can easily be adapted to function in accordance with the device of the present invention.

The invention further relates to a method for a multimode display device of visually handling audio applications on the display area, where said display device is, in a first mode, adapted for displaying display-focused applications on the display area, where said display device is, in a second mode, adapted for displaying said audio-specific information on the display area and where the display device is, in a third mode, adapted for simultaneously displaying independent display-focused applications and audio-specific information on the display area, the method comprises the steps of:
receiving audio data comprising said audio-specific information;
displaying said audio-specific information on said display area.

In an embodiment the device further comprises storage means adapted for storing the received audio-specific information and wherein said audio-specific information being displayed on said display area is read from said storage means.

In another embodiment the device comprises a connector for connecting an external audio source and wherein the device receives said audio data comprising audio-specific information from said audio source via said connector.

In another embodiment the device further comprises a means for receiving input from a user of the display device and wherein the method comprises the step of:
receiving an input from the user of the display device indicating in which mode the display is to be used,
displaying said audio-specific information on said display area if said second or third mode is selected.

In the following preferred embodiments of the invention will be described referring to the figures, where

FIG. 1 illustrates an LCD monitor according to the present invention, where the monitor comprises an integrated audio source;

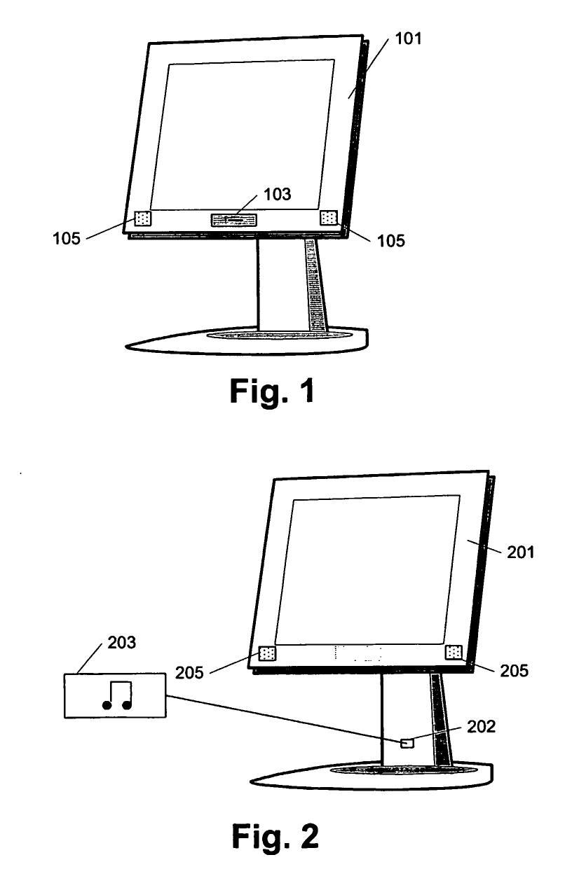

FIG. 2 illustrates an LCD monitor according to the present invention, where the monitor comprises a connector for connecting to an external audio source;

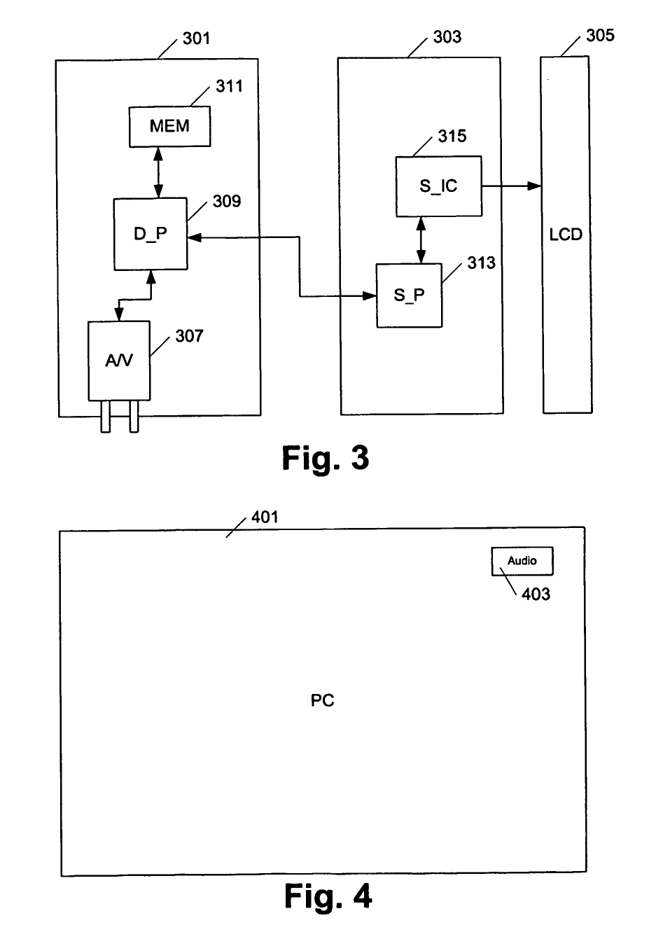

FIG. 3 illustrates the elements in an LCD monitor according to the present invention being adapted for playing back audio;

FIG. 4 illustrates the display area of a multimode display device simultaneously playing back audio, while the display is being used for an independent audio application;

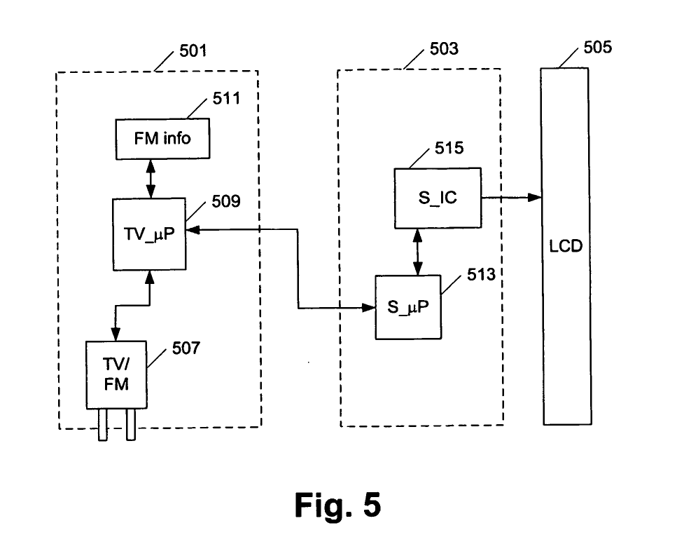

FIG. 5 illustrates the elements in a multimode display device, when the device is an LCD-TV monitor with FM radio functionality;

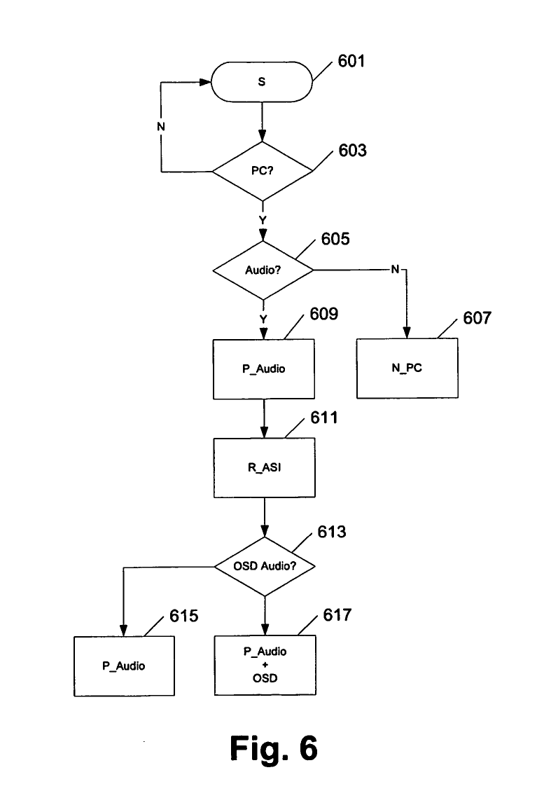

FIG. 6 illustrates a logic diagram of visually handling audio in a display device according to the present invention.

In FIG. 1 a multimode display device according to the present invention is illustrated, where the display device 101 comprises means for playing back audio being an integrated audio playback device 103. In the example the playback device 103 is an integrated mp3 player where memory cards comprising mp3 music can be inserted and played back by the playback device 103. The display device 101 could also have other types of integrated audio playback devices such as a device for playing back stored audio from a DVD, CD and/or a receiver for playing back the audio in a received radio audio signal. In the example the display device 101 further comprises a set of speakers 105 for providing stereo sound, alternatively a plug could be provided for attaching external speaker and/or headphones. The display device 101 is adapted for displaying on the display area audio- specific information describing audio being played back by the playback device 103.

In FIG. 2 an alternative embodiment of a multimode display device 201 according to the present invention is illustrated, where the display device 201 comprises a connector 202 for connecting an external audio source 203 being e.g. an external audio playback device. The connector could e.g. be a USB plug, enabling the display device 201 to receive audio data comprising audio-specific information from the external audio source 203. The external audio source 203 could be an mp3 player where memory cards comprising mp3 music can be inserted and played back by the player. Alternatively the audio data could be received by the display device 201 and played back by integrated processing means adapted for playing back the audio. The display device 201 could be connected to other types of external audio sources 203 such as a device for playing back stored audio from a DVD, CD and/or a receiver for playing back the audio in a received radio audio signal. In the example the display device 201 further comprises a set of speakers 205 for providing stereo sound, alternatively a plug could be provided for attaching external speaker and/or headphones. The display device 201 is adapted for displaying on the display area audio-specific information describing audio being played back either by the audio source 203 or by the integrated processing means adapted for playing back the audio.

FIG. 3 illustrates the elements in a multimode display device according to the present invention, where the display device is an LCD display. The device comprises three parts: a front end 301 for processing the input signals, a back end 303 for handling how the data are to be reproduced on the display area and a display area being an LCD panel 305, respectively. The front end 301 comprises an audio/video input 307 for receiving respectively the video information to be displayed on the display area (e.g. a signal from a graphic adapter in a PC) and the audio data comprising audio-specific information which is to be displayed on the display area. The front end further comprises processing means 309 for handling the received data which could comprise processing the video data to extract the data needed in order to display the video information on the display properly. The processing means 309 could further be adapted to extract audio-specific information to be displayed from the audio data, this information could e.g. be stored in the storage means 311, whereby availability of the data is ensured. Next the display data are transferred to the scaler back end and based on which mode the multimode monitor is operated in, the scaler part ensures that information is provided accordingly on the display area being the LCD panel. The scaler processor 313 and the scaler IC 315 ensure that, in a first mode, the display device displays display-focused applications on the display area e.g. PC screen. In a second mode, the display device displays audio-specific information on the display area describing audio being played back by the playback device. In a third mode, the display device simultaneously displays independent display-focused applications and audio-specific information on the display area.

In FIG. 4 the display area of a multimode display device is illustrated, where the display device is operated in the third mode simultaneously displaying audio-specific information describing audio being played back by a playback device and display-focused applications on the display area. In the example the display-focused application is functionality as a PC monitor 401, further the audio-specific information 403 is an icon positioned in the corner of the screen in order not to obstruct a significant area of the PC screen. The audio-specific information could be the title of a song being played back. Alternative it could be frequency of the FM radio channel, when the playback device is a FM radio tuner. How the display-focused application and the audio-specific information, respectively, are to be displayed on the display area can be determined independently by the processing means in the back end.

In FIG. 5, the elements in a multimode display device being a combined LCD monitor and LCD TV is illustrated, where the monitor can additionally be used for listening to FM radio and viewing TV. The device comprises three parts: a TV front end 501 for processing the received TV and radio information, a scaler panel 503 for handling how the data are to be reproduced on the display area and a display area being an LCD panel 505, respectively. The TV front end 501 comprises a TV and FM radio tuner 507 for receiving respectively the TV and radio signal. The front end further comprises processing means 509 for handling the received data which could comprise processing the TV signal and extracting audio-specific information from the radio signal to be displayed; this information could e.g. be stored in the storage means 511 being an EEPROM or NVM, whereby availability of the data is ensured. The display further comprises a back end 503 and based on which mode the multimode monitor is operated in, the scaler part ensures that information is provided accordingly on the display area being the LCD panel. The scaler processor 513 and the scaler IC 515 ensures that, in a first mode, the display device displays display-focused applications on the display area e.g. PC screen. In a second mode, the display device displays audio-specific information on the display area describing the audio being played back by the playback device e.g. the FM radio frequency. In a third mode, the display device simultaneously displays independent display-focused applications and audio-specific information on the display area.

In FIG. 6, a logic diagram of visually handling audio in a multimode display device according to the present invention is illustrated. The flowchart starts in 601, and in 603 it is determined whether the display device is operated as a PC monitor (PC?), if not the control is restarted. If the device is operated as a PC monitor then in 605 it is determined whether the device is to be used for playing back audio e.g. radio (Audio?), if not 607 the device is operated as a normal PC monitor (N_PC) where the whole display area is used for the PC. When the device is used for audio playback, then audio playback (P_Audio) is started 609 and the audio is reproduced e.g. by using integrated speakers. In 611 the audio-specific information is retrieved either by reading it (R_ASI) from local storage means or by directly extracting it from the received audio signal. In 613 it is determined, based on a user selection, whether the audio-specific information is to be displayed on the screen or not (OSD Audio?). If not the audio is played back through the speakers, but only the PC screen is displayed on the display area otherwise also the audio-specific information is displayed.

It is noted that the above may be implemented as general- or special-purpose programmable microprocessors, Digital Signal Processors (DSP), Application Specific Integrated Circuits (ASIC), Programmable Logic Arrays (PLA), Field Programmable Gate Arrays (FPGA), special-purpose electronic circuits, etc., or a combination thereof.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A multimode display device comprising a display area, where said display device is, in a first mode, adapted for displaying display-focused applications on the display area, where said display device is, in a second mode, adapted for displaying audio-specific information on the display area describing audio being played back and where the display device is, in a third mode, adapted for simultaneously displaying independent display-focused applications and audio-specific information on the display area, the device comprises:
receiving means adapted for receiving audio data comprising said audio-specific information;
processing means adapted for displaying said audio-specific information on said display area.

2. A multimode display device according to claim 1, wherein the device comprises means for playing back said audio.

3. A multimode display device according to claim 1, wherein the device further comprises storage means adapted for storing the audio-specific information; and wherein the processing means is adapted for reading said audio-specific information from said storage means.

4. A multimode display device according to claim 1, wherein the device comprises a connector for connecting an external audio source enabling the device to receive said audio data comprising audio-specific information from said audio source via said connector.

5. A multimode display according to claim 1, wherein the display area is an LCD display.

6. A multimode display device according to claim 1, wherein the processing means for displaying said audio-specific information on said display area is a scaler comprised in said display device.

7. A method for a multimode display device of visually handling audio applications on the display area, where said display device is, in a first mode, adapted for displaying display-focused applications on the display area, where said display device is, in a second mode, adapted for displaying said audio-specific information on the display area and where the display device is, in a third mode, adapted for simultaneously displaying independent display-focused applications and audio-specific information on the display area, the method comprising:
receiving audio data comprising said audio-specific information;
displaying said audio-specific information on said display area.

8. A method according to claim 7, wherein the device further comprises storage means adapted for storing the received audio-specific information; and wherein said audio-specific information being displayed on said display area is read from said storage means.

9. A method according to claim 7, wherein the device comprises a connector for connecting an external audio source and wherein the device receives said audio data comprising audio-specific information from said audio source via said connector.

10. A method according to claim 7, wherein the device further comprises a means for receiving input from a user of the display device and wherein the method comprises the step of:
receiving an input from the user of the display device indicating in which mode the display is to be used;
displaying said audio-specific information on said display area if said second or third mode is selected.
